(19) United States
(12) Patent Application Publication
(10) Pub. No.: US 2008/0185749 A1
(43) Pub. Date: Aug. 7, 2008

(54) Sodium silicate treated fibrous composites

(76) Inventor: Kenneth P. Kastner, Jenison, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/701,106

(22) Filed: Feb. 1, 2007

(51) Int. Cl. B27N 3/00; B28B 1/14

(52) U.S. Cl. 264/109; 264/299; 442/1; 442/394

(57) ABSTRACT

A lightweight composite panel exhibiting a high degree of stiffness and strength includes a non-woven fibrous batt comprising more than 50% by weight synthetic fibers, and a geopolymer disposed on and/or within the fibrous batt to impart rigidity to the composite panel. The composite panel may include additional functional and/or aesthetic layers, and may be either flat or contoured. The resulting panels have various architectural, automotive and furniture applications.

### FIELD OF THE INVENTION

This invention relates to the field of architectural, furniture and automotive panels, and more particularly to relatively rigid, lightweight composite panels.

### BACKGROUND OF THE INVENTION

Thermoformable panels are frequently used in interior automotive and interior architectural applications, with typical applications including automotive headliners and trunk liners, ceiling tiles, etc. Thermoformable panels are typically comprised of fibrous mats having thermoplastic fibers, beads or other thermoplastic materials that melt upon heating in a thermoforming fixture and subsequently solidify upon cooling to bind fibers together in a fixed orientation relative to each other to maintain the panel in a shape as defined by the fixture. While the resulting shaped articles formed using known thermoformable panels have excellent shape retention properties, they have very little strength or stiffness, generally limiting their application to arrangements in which the shaped panel is nested in a conforming rigid structure. In particular, such thermoformable fibrous panels do not have sufficient rigidity and strength for furniture and exterior shaped panel applications.

Rigid panels are used for various exterior architectural applications, such as exterior siding, soffits, etc. These panels are typically extruded and/or molded articles that are relatively densely packed, heavy, and essentially solid materials that are free or substantially free of internal voids. Examples of such materials include extruded aluminum, extruded vinyl polymers and the like.

Rigid panels used for furniture applications are typically comprised of cellulose fibers, particles, chips or the like that are impregnated with a resinous material and shaped, typically into flat boards or panels, under application of high pressure. These panels can exhibit excellent rigidity and strength, but are relatively dense and heavy. Further, the ability to shape panels comprised of cellulosic fibers, particles, chips or like is extremely limited.

United States Patent Application Publication No. 2006/0252323 discloses a fire-resistant, acoustical absorbing article comprising a bast fiber component, a thermoplastic binder, and a first fire-retardant component, which is coated with a material containing a second fire-retardant component. The article is prepared by combining a thermoplastic material with bast fibers (i.e., fibers from the inner bark of woody plants, such as kenaf, jute, hemp, sisal or flax fibers), dispersing the first fire-retardant component in the mixture, heating the mixture to soften or melt the thermoplastic material, compressing the heated mixture to form a shaped article, and applying a coating containing the second fire-retardant component to the surface of the shaped article. The bast fibers comprise at least 50% by weight of the article (prior to coating), and the first fire-retardant comprises at least 10% by weight of the article (prior to coating). The first fire-retardant component may be selected from borates, polyborates, boric acid, borax, and phosphates. The second fire-retardant component, which is applied as a coating to the surface of the article, is a geopolymer. The resulting article exhibits strength and rigidity suitable for use as a structural component for office furniture, office partitions, and ceiling tiles. However, the articles are relatively dense and heavy.

United States Patent Application Publication No. 2006/0251909 discloses geopolymer composites and articles formed from the geopolymer composites. The geopolymers are employed as a binder in the composites in an amount of at least 2% by weight. The balance of the composite is comprised of particulate ceramic filler. However, there is not any suggestion for using a geopolymer as a binder for fibrous composites.

### SUMMARY OF THE INVENTION

The invention in its various aspects is directed to composite panels which are relatively light in weight, and which are relatively strong and rigid. The composite panels of the invention include a non-woven fibrous batt comprising synthetic polymer fibers and a geopolymer disposed on and/or within the fibrous batt to impart rigidity to the composite panel. In accordance with certain aspects of the invention, one or more additional layers of materials may be bonded to the fibrous batt to impart functional and/or aesthetic properties.

In accordance with another aspect of the invention, a process for making a rigid, lightweight contoured article is provided. The process generally includes steps of providing a non-woven fibrous batt comprising synthetic polymer fibers, contouring the non-woven fibrous batt in a fixture, and applying to at least one of two major surfaces of the contoured fibrous batt a geopolymer that coats and/or impregnates fibers on at least one of two opposing major surfaces of the non-woven fibrous batt.

These and other features, advantages and objects of the present invention will be further understood and appreciated by those skilled in the art by reference to the following specification, claims and appended drawings.

### BRIEF DESCRIPTION OF THE DRAWINGS

FIG. 1 is an elevational cross section of a first embodiment of the invention in which a geopolymer is impregnated into regions of a fibrous batt adjacent the opposite surfaces of the batt.

FIG. 2 is an elevational cross section of a second embodiment of the invention illustrating a multiple layer composite in which the geopolymer may be disposed on or within either an outer layer or an inner layer of material.

FIG. 3 is an elevational cross section of a third embodiment illustrating a four layer structure in which a core non-woven fibrous batt layer is impregnated with a geopolymer and/or in which additional scrim layers are bonded to the core of the geopolymer, and in which a decorative film is bonded to one of the scrim layers.

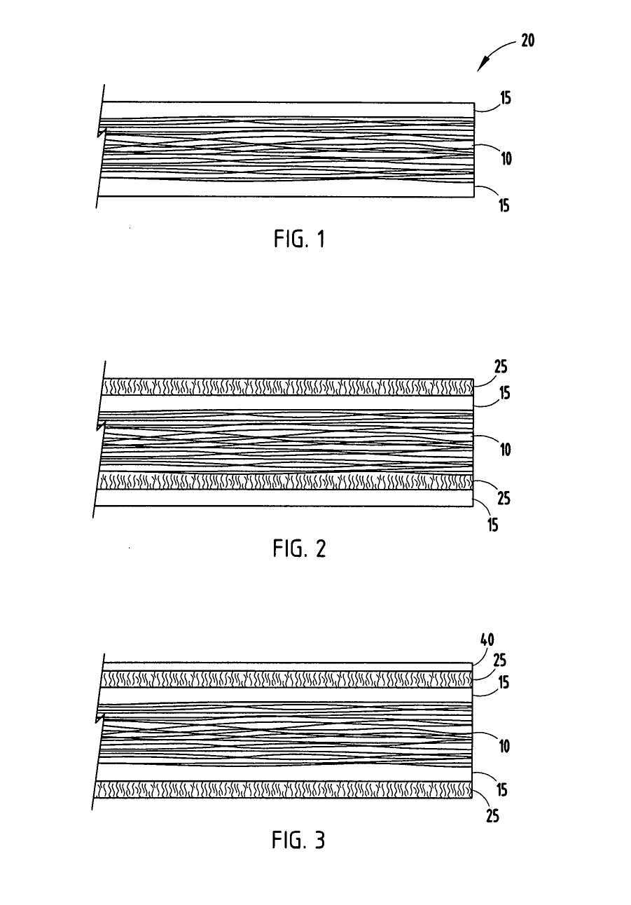

### DETAILED DESCRIPTION OF PREFERRED EMBODIMENTS

In accordance with all of the various embodiments of this invention, a layer comprised of synthetic fibers is coated and/or impregnated with a geopolymer to provide a composite panel that is light, yet exhibits exceptional strength and rigidity.

In one embodiment, a non-woven fibrous batt 10 comprising more than 50% by weight of synthetic polymer fibers is coated and/or impregnated with a geopolymer 15 to impart rigidity to the resulting composite panel 20. The non-woven batt may be comprised of generally any combination of synthetic, natural and/or mineral fibers. However, in order to provide the desired combination of lightweight, rigidity and strength in a low cost panel, the non-woven fibrous batt is comprised primarily of synthetic polymer fibers (i.e., more that 50% by weight). Preferably, the non-woven fibrous batt is comprised of at least 75% synthetic polymer fibers by weight. Natural fibers that may be employed include kenaf, grasses, rice, hulls, bagasse, cotton, jute, hemp, flax, bamboo, sisal, abaca and wood fibers. Examples of mineral fibers include glass, ceramic and metal fibers. However, mineral fibers are generally not preferred because they undesirably add weight to the composite panels. The synthetic polymer fibers that may be employed in the non-woven fibrous batt are generally thermoplastic fibers, such as polyester fibers, nylon fibers, polyethylene fibers, polypropylene fibers, and blends of these thermoplastic fibers.

In those cases in which the composite panel is shaped or contoured to form an article, the non-woven, fibrous batt preferably comprises a sufficient quantity of heat activatable thermoplastic fibers that will impart desirable shape retention properties. The non-woven fibrous batt is heated in a tool or fixture to a temperature at or above the activation temperature of the heat activatable fibers and subsequently cooling to a temperature below the activation temperature before removing the contoured article from the tool or fixture. Suitable heat activatable thermoplastic fibers that can be softened and/or at least partially melted upon application of heat during a thermoforming process to form a multiplicity of bonds at fiber-fiber intersections to impart shape retention properties include those comprised of homopolymers and copolymers of polyester, nylon, polyethylene, polypropylene and blends of fibers formed from these polymers and copolymers. Particularly suitable are composite of bicomponent fibers having a relatively low melting binder component and a higher melting strength component. The relatively lower melting binder component is selected to melt at a predetermined temperature to which the fibrous batt is heated while in a contouring or shaping tool or fixture, with the higher melting strength component being selected so that it does not melt during heating to the predetermined temperature in the fixture or tool. Bicomponent fibers of this type are particularly advantageous because the strength component imparts and maintains adequate strength to the fiber while the bonding characteristics are imparted by the low temperature component. A variety of bicomponent fibers of this type are commercially available from various sources. One suitable fiber for use in the present invention is a sheath-core bicomponent structure wherein the core is formed of a variety of high melting polyethylene terephthalate (PET) polymer and the sheath comprises PET copolymer having a lower melting temperature which exhibits thermoplastic adhesive and thermoformability properties when heated to a temperature of about 185° F. to 210° F. The amount of heat activatable fiber is selected to provide a desired shape retention property for a particular panel structure used in a particular application.

In those cases where the panels remain flat (i.e., are not shaped or contoured), such as for ceiling tile applications, exterior siding applications, and the like, it may be desirable to omit the heat activatable thermoplastic fibers. Alternatively, other thermoplastic binder materials, such as thermoplastic beads, may be used for imparting shape-retention properties to a contoured panel during thermoforming. Further, other types of bicomponent fibers, such as side-by-side coextruded bicomponent fibers may be employed instead of the sheath-core bicomponent fibers. In those cases where shape-retention properties are desired, suitable amounts of heat activatable thermoplastic fibers or other thermoplastic binder materials range from about 5% to about 50% by weight of the fibrous batt. Greater amounts may be employed, but may unnecessarily add to the cost of making the desired contoured articles. Further, amounts less than 5% may, in some cases, be employed.

The non-woven fibrous batt is preferably a lofted fibrous batt in which the average fiber orientation is less than 35 degrees from the thickness direction of the batt. The term “non-woven fibrous batt” as used herein refers to a non-woven mass of fibers in which the fibers are at least sufficiently intertwined to be handled in a sheet form having a substantial length and width, with a thickness that is substantially less than the length or width. Typically, the thickness of the non-woven fibrous batt is less than 10% of the length and/or width. Even more preferred are highly lofted fibrous batts (e.g., vertically-lapped fibrous batts such as those prepared using a Struto machine) in which the average fiber orientation is less than 30 degrees from the thickness direction of the batt, i.e., the fibers are predominantly oriented along the thickness direction of the batt.

A geopolymer is a material prepared from geosynthesis of polymeric alumino-silicates and alkali-silicates. The resulting geopolymer has a three-dimensional framework of linked SiO₄ and AlO₄ tetrahedra. Geopolymers can obtain a high strength and can set (solidify) in as little as a few hours at room temperature. Geopolymerization is a geosynthesis (i.e., a reaction that chemically integrates minerals) that involves the reaction of silico-aluminates to form molecules that are chemically and structurally comparable to the materials binding natural rock. As a result, geopolymers exhibit a hardness, chemical stability and longevity that is equal to that of natural geologic materials. The geopolymers that may be employed for preparing the composition panels of this invention include water glasses such as sodium or potassium silicates and aluminous clays. Kasil-1, a potassium silicate aqueous solution available from PQ Corporation of Berwyn, Pa., contains approximately 29.1% by weight solids including 8.3% by weight K₂O and 20.8% by weight SiO₂ in solution. The solution may be modified by additional silica in the form of colloidal silica in order to increase the silica content, or by additions of KOH in order to decrease the silica content. A suitable colloidal silica is Ludox available from Grace Davison of Columbia, Md. Boric oxide or boric acid (HBO₃) may be added to the solution. Activated aluminum silicate clays such as meta-kaolin (Al₂O₃.2SiO₂) may be added to react with the alkali-silicate to initiate the geopolymer formation. Activated aluminum silicate clays also provide alumina to serve to control the (Na+K)/Al atomic ratio. A (Na+K)/Al atomic ratio of approximately 1:1 is suitable. Activated or calcined kaolin such as Glomax LL, available from Dry Branch Kaolin Co. of Dry Branch, Ga., is one suitable clay. Activated kaolin is typically formed by prefiring hydrous kaolin at approximately 800° C. to drive off structural water without converting the kaolin to mullite.

The preferred geopolymers are poly(silico-oxo-aluminate) having a ratio of Si:Al of from about 1:1 to about 15:1, and either more preferably from about 2:1 to about 10:1.

The geopolymer precursor solution may be applied to one or both of the opposite major surfaces of the non-woven fibrous batt (i.e., the surfaces coinciding with a plane defined by the length and width directions of the fibrous batt). Generally any solution application technique that is capable of depositing a suitable amount of geopolymer on the fabric surface (e.g., from about 5 to about 25 grams per square foot of fabric surface) may be employed. Such techniques include immersion, flip coating, slot coating, curtain coating, spraying, etc. Typically, the liquid precursor solution has a solids content of about 20 to 50%, more typically about 35 to 45%. After a suitable amount of geopolymer precursor solution is applied to one or both of the coated and/or impregnated fibrous batt is allowed to dry, such as in an oven, to cause thermosetting of the geopolymer. Typically, an amount of heating and a drying time that is sufficient to remove substantially all of the water (e.g., so that there is less than about 5% residual water) is sufficient to achieve the desired integration of the geopolymer into the composite panel. Depending on the application technique used, the geopolymer may be distributed throughout the thickness of the non-woven fibrous batt, but is more typically predominantly present on at least one of the opposing major surfaces of the panel and/or within pores adjacent the opposing major surface (i.e., impregnated into the portion of the fibrous batt adjacent its surface). The geopolymer applied to the non-woven fibrous batt provides a composite panel having a surprisingly high degree of rigidity and strength for a lightweight panel comprised primarily of synthetic fibers.

In accordance with various aspects of the invention additional layers of material may be laminated to a surface of the fibrous batt. The expression “laminated” as used herein refers to bonding of adjacent layers. This may be achieved by employing any of a variety of techniques, including the use of conventional adhesives, needle-punching, or both.

In accordance with various aspects of the invention, additional layers of materials such as decorative film layers, one or more reinforcing scrim layers or the like may be employed. For example, a scrim layer 25 may be laminated to one or both of the opposite major surfaces of the fibrous batt 10 to add additional strength and rigidity (FIG. 2). The expression “scrim layer” as used herein refers to a fabric that is not lofted or has a very low loft. In general, unlike the preferred non-woven fibrous batts, which are lofted fabrics, the scrim layers have essentially no vertically-oriented fibers or at least an extremely low proportion of vertically-oriented fibers (e.g., the average fiber orientation is from about 60 degrees to about 90 degrees from the thickness direction of the scrim layer, i.e., predominately oriented in a direction or directions perpendicular to the thickness direction of the scrim). Suitable scrim layers may be comprised of generally any combination of synthetic, natural and mineral fibers, and may be either woven or non-woven. The scrim layers may also be distinguished from a non-woven fibrous batt by their thickness and/or basis weight. A scrim layer typically has a thickness in the range of from about 0.5 to 1.5 millimeters and a basis weight (weight per unit area of fabric) in range of from about 20 to about 40 grams per square foot, whereas the non-woven fibrous batt typically has a basis weight in the range of from about 60 to about 120 grams per square foot, and a typical thickness in range from about 8 millimeters to about 12 millimeters prior to thermoforming, and a thickness in the range of from about 4 to about 6 millimeters in a finished article after thermoforming.

For certain applications, such as exterior siding, a decorative film layer 40 having surface indicia may be laminated on an exterior side of the geopolymer treated non-woven fibrous batt 10, on a reinforcing scrim layer 25 laminated to a geopolymer treated non-woven fibrous batt, or to a geopolymer treated scrim layer laminated to a non-woven fibrous batt (FIG. 3). More particularly, in accordance with one embodiment of the invention, there is provided a composite panel comprising a non-woven fibrous batt and a scrim layer laminated to at least one of two opposite opposing major surfaces of the non-woven fibrous batt, with a geopolymer disposed on and/or within one of the non-woven fibrous batt or the scrim layer. Also contemplated is a composite panel having a non-woven fibrous batt with a scrim layer bonded to one or both of the two opposite opposing major surfaces of the non-woven fibrous batt, and geopolymer disposed on the scrim layer or layers. The resulting composite has exceptional strength and rigidity for a lightweight composite comprised predominantly of synthetic fibers.

In accordance with certain aspects of the invention, it may be possible to utilize the geopolymer as a binder. In accordance with this aspect of the invention, a non-woven fibrous batt, either contoured by thermoforming, or flat, may be treated by applying a geopolymer precursor solution to at least one of two opposite opposing major surfaces of the non-woven fibrous batt, and applying an additional layer of material to the geopolymer treated surface before it is dried, optionally with the application of pressure and heat, to achieve bonding of the additional layer to the non-woven fibrous batt by employing the geopolymer as a binder.

The expression “thermoforming” as used herein refers to the use of a heated fixture used for shaping a fibrous composite panel, typically employing relatively low pressures and temperatures (e.g., pressures on the order of only a few psi and temperatures on the order of about 210° C. or less). During thermoforming, the fibrous composite may be compressed in certain areas providing a finished article having variable thickness, and/or having curves or bends, such that the exposed surface of the composite panel is not planar or substantially planar.

As another alternative to the use of thermoplastic binding materials during thermoforming to impart shape or contour-retaining property, a thermosetting or thermosettable resin material that reacts when heated to a predetermined temperature in a thermoforming mold may be employed. In this case, the thermosettable binder material chemically reacts at the predetermined temperature to cause the thermosettable binder material to set or cure and bind together adjacent fibers that have reoriented during the step of contouring or shaping in a thermoforming fixture, whereby the resulting composite panel is provided with a contour retention property.

A combination of thermoforming and application of a geopolymer may be utilized to make a rigid, lightweight contoured article. In accordance with this process, a non-woven fibrous batt comprising synthetic fibers is contoured or shaped in a fixture, and subsequently a geopolymer is applied to at least one of two major surfaces of the contoured fibrous batt to coat and/or impregnate fibers at or near the surface of the batt. Either thermoplastic binder materials or thermosettable binding materials may be employed to impart shape or contour-retention property to the contoured article prior to application of the geopolymer.

The use of a geopolymer in association with a non-woven fibrous batt comprised of thermoplastic fibers provides a low cost method of achieving strength and stiffness properties which were not previously achievable in composite panels comprised primarily of synthetic fibers. In addition, the geopolymer can act as an inexpensive binder for laminating fabric layers together and/or for providing contour-retention property to a composite comprised primarily of synthetic fibers.

The resulting composite panels and contoured articles of this invention may be utilized for architectural components such as soffits, exterior siding, etc.; in furniture applications, such as flipper doors; automotive applications such as automobile headliners and trunk liners, and interior architectural applications such as ceiling tiles and wall panels. In addition to having excellent strength and rigidity for a lightweight composite, the panels and shaped articles of the invention exhibit acoustic attenuating properties.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A composite panel comprising:
a non-woven fibrous batt comprising more than 50% by weight of synthetic polymer fibers; and
a geopolymer disposed on and/or within the fibrous batt to impart rigidity to the composite panel.

2. The composite panel of claim 1, wherein the non-woven fibrous batt comprises thermoplastic fibers in an amount greater than 75% by weight.

3. The composite panel of claim 1, wherein the geopolymer is a poly(silico-oxo-aluminate) having a ratio of Si:Al of from about 1:1 to about 15:1.

4. The composite panel of claim 1, wherein the geopolymer is predominately present on at least one of opposing major surfaces of the panel and wherein pores adjacent the at least one opposing major surface.

5. The composite panel of claim 1, wherein the geopolymer is predominately present on both of two opposing major surfaces of the panel and within pores adjacent the opposing major surfaces.

6. The composite panel of claim 1, further comprising at least one additional layer of material laminated to a surface of the fibrous batt.

7. The composite panel of claim 6, wherein the at least one additional layer of material laminated to the surface of the fibrous batt is a decorative film layer having surface indicia on an exterior side opposite the surface of the fibrous batt.

8. The composite panel of claim 1, wherein the fibrous batt comprises a blend of synthetic and natural fibers.

9. The composite panel of claim 1, wherein the fibrous batt comprises bicomponent fibers having a low melting binder component and a higher melting strength component.

10. The composite panel of claim 1, wherein the fibrous batt is comprised of fibers that are predominately orientated in a direction perpendicular to the major surface of the fibrous batt.

11. A composite panel comprising:
a non-woven fibrous batt comprising thermoplastic fibers;
a scrim layer laminated to at least one of two opposite opposing major surfaces of the non-woven fibrous batt; and
a geopolymer disposed on and/or within one of the non-woven fibrous batt or the scrim layer.

12. The composite panel of claim 11, in which a scrim layer is laminated to both of the two opposite opposing major surfaces of the non-woven fibrous batt.

13. The composite panel of claim 11, further comprising at least one additional layer of material laminated to one of the scrim layer or the non-woven fibrous batt.

14. The composite panel of claim 12, further comprising a decorative film layer having surface indicia on an exterior side laminated to one of the scrim layers.

15. An article comprising:
a contoured non-woven fibrous batt comprising more than 50% synthetic thermoplastic fibers by weight and a geopolymer disposed on and/or within the non-woven fibrous batt.

16. A process for making a rigid, lightweight contoured article, comprising steps of:
providing a non-woven fibrous batt comprising more than 50% by weight synthetic polymer fibers;
contouring the non-woven fibrous batt in a fixture; and
applying to at least one of two major surfaces of the contoured fibrous batt a geopolymer that coats and/or impregnates fibers on at least one of the two opposing major surfaces of the non-woven fibrous batt.

17. The process of claim 16, in which the fibrous batt includes a thermoplastic binder material having a component that softens or melts at a predetermined temperature, and in which sufficient heat is applying during the contouring step to soften or melt the thermoplastic binder material during the step of contouring the non-woven fibrous batt, so that adjacent fibers reoriented during the step of contouring are bound together by the thermoplastic binder material to impart a contour retention property upon being subsequently cooled below the softening or melting temperature of the binder material.

18. The process of claim 17, wherein the binder material is a bicomponent fiber having a first thermoplastic component that softens or melts at a predetermined temperature to which the fibrous batt is heated during contouring, and a second thermoplastic component that does not soften or melt at the predetermined temperature.

19. The process of claim 16, in which the fibrous batt includes a heat activated thermosettable binder material that chemically reacts at a predetermined temperature, and in which sufficient heat is applied during the contouring step to cause the thermosettable binder material to chemically react and bond together adjacent fibers that have reoriented during the step of contouring to impart a contour retention property to the fibrous batt upon thermosetting of the binder material.

20. The process of claim 16, wherein the non-woven fibrous batt comprises thermoplastic fibers in an amount greater than 75% by weight.
